(19) United States
(12) Patent Application Publication
(10) Pub. No.: US 2003/0208297 A1
(43) Pub. Date: Nov. 6, 2003

(54) System for accessing a programmable automatism unit based on a wap architecture

(75) Inventors: Jean-Marie Stawikowski, Antibes (FR); Christophe Vincent, La Roquette-Sur-Siagne (FR); Christian Hardy, Le Thoronet (FR); Robert Rousseau, Antibes (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Schneider Automation, Valbonne (FR)

(21) Appl. No.: 09/822,341

(22) Filed: Apr. 2, 2001

(30) Foreign Application Priority Data
Mar. 31, 2000 (FR) 00 04669

(51) Int. Cl. G06F 15/16

(52) U.S. Cl. 700/219

(57) ABSTRACT

The present invention relates to a system for accessing a programmable automatism unit (10) based on a WAP architecture, from at least a standalone communicating mobile device (40), such as a portable telephone, which integrates a navigator (41) complying with WAP architecture. This system includes a Web server (20), embedded in a piece of automatism equipment of the automatism unit (10), capable of generating static or dynamic informative data according to the WML language, and a network interface (30), connected to the Web server (20) through a network (25) of the Internet type, which authorizes access to said informative data from a WAP navigator (41) of a mobile device (40) communicating through a wireless network (35), in such a way that a user of such a WAP navigator (41) may access functions for monitoring, viewing and controlling the automatism unit (10).

The present invention relates to a system for accessing a programmable automatism unit from at least a standalone communicating mobile device, such as a portable telephone. This access system is based on a WAP architecture and it may be applied to any application belonging to the field of industrial automatisms, building automatisms or automatisms for monitoring/controlling electrical distribution networks.

Accessing an automatism unit from a standard Web navigator through an Internet or Intranet type network by using a Web server embedded in the automatism unit and capable of generating HTML formatted files is already known. Thus, the variables of the automatism unit may be accessed as HTLM formatted pages through an innovative approach, by using the multiple resources of an Internet type network. These possibilities are described in several patent documents, for example in U.S. Pat. No. 5,805,442, U.S. Pat. No. 5,975,737 and WO 99134418. However, such a solution forces its user to resort to a device having a connection to an Internet or Intranet type network and capable of integrating a standard Web navigator.

Now, there is an increasing need for wanting to access variables of an automatism unit, notably for diagnose or maintenance operations, from standalone communicating mobile devices. In the following discussion, these mobile devices encompass portable telephones, PDA (Personal Digital Assistant) type devices or any pocket format mobile device (handheld device); they are characterized i.a. by their simple user interface (small screen size) and their connection to a wireless network. These features notably lead to a limitation of the available bandwidth for communications, a less good availability of the network and a limitation of the screen display capacity. Consequently, standard Web navigators are not adapted to this type of devices.

The WAP (Wireless Application Protocol) architecture was elaborated by the “WAP Forum” (http://www.wapforum.org/) in order to define a global specification enabling mobile devices having a micronavigator, hereafter designated as WAP navigator, to communicate without any wire link on an Internet type network by using a WML (Wireless Markup Language) language. This language which complies with the syntax of the WML metalanguage and with the HTTP communications standard, was designed for small screens and consequently is much better adapted to mobile devices than the HTML language.

The WML language includes the contents of WML source, WMLScript source, compiled WML, compiled WMLScript, WBMP image, etc . . . . In the present invention, these different contents are grouped together under the name of WML language. All these contents are accessible through Internet by using standard HTTP requests.

Accordingly, the object of the invention is to be able to provide users of communicating mobile devices with a WAP navigator, with the possibility of remote communications with an automatism unit through a wireless network, by applying the possibilities of a global Internet, Intranet or Extranet type network wherein one of the applications of this access system is e.g. facilitating the work of maintenance workers which have to move around on an extensive site or different sites.

For this, the invention describes a system for accessing a programmable automatism unit based on a WAP architecture, from at least a standalone communicating mobile device, such as a portable telephone, which integrates a navigator complying with a WAP architecture. The described system includes a Web server embedded in a piece of automatism equipment from the automatism unit, capable of generating static or dynamic informative data coded according to the WML language, wherein these informative data may provide functions for monitoring, viewing and controlling the automatism unit. The Web server is connected through an Internet, Intranet or Extranet type global network to a network interface which authorizes access to said informative data from the WAP navigator of a mobile device which communicates in such a way that a user of such a WAP navigator may access functions for monitoring, viewing and controlling the automatism unit.

The Web server may receive through the network interface a WAP command as a HTTP request specifying a URL address and, in response to this WAP command, the Web server generates static or dynamic informative data coded in WML language which may provide the user of a WAP navigator implemented in a communicating mobile device, with functions for monitoring, viewing and controlling the automatism unit. On the other hand, the Web server may send, on its own initiative or on the initiative of the automatism unit, notification to at least a communicating mobile device by using the “Push Access Protocol” as defined in the WAP architecture, so that the user of a WAP navigator implemented in a communicating mobile device, may be informed of events or conditions concerning the automatism unit.

Other features and advantages will become apparent in the detailed description which follows, with reference to an exemplary embodiment and illustrated by the appended drawings wherein:

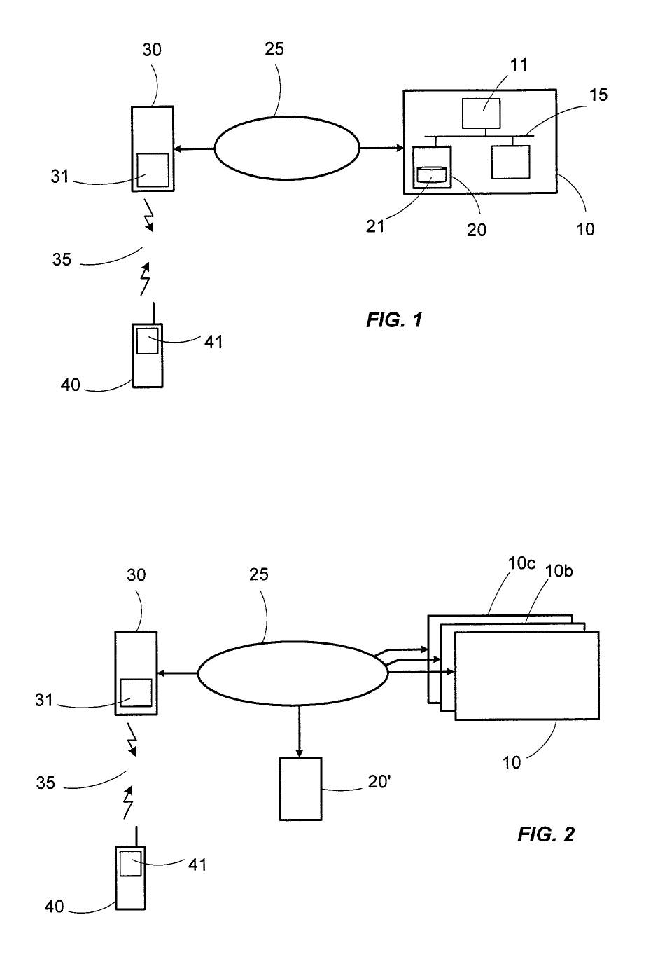

FIG. 1 illustrates a first example of communications architecture according to the invention,

FIG. 2 illustrates another example of communications architecture according to the invention,

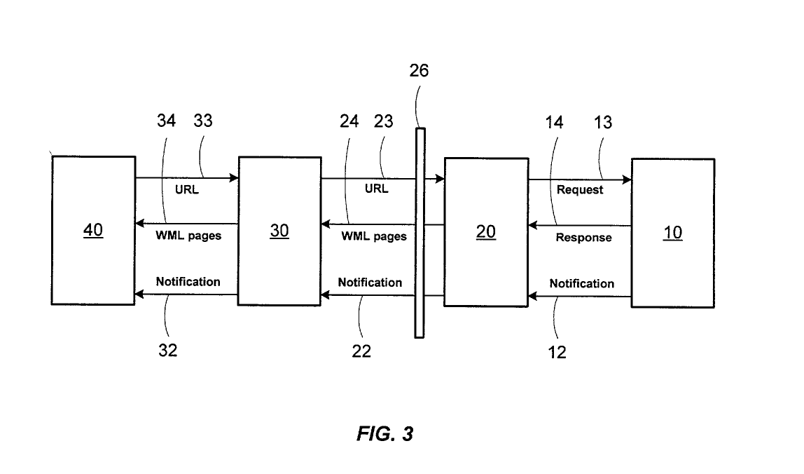

FIG. 3 provides a simplified diagram of the communications between the components of the access system.

A programmable automatism unit 10 as defined in the present invention, comprises one or several pieces of automatism equipment 11 and is most particularly intended for monitoring/controlling industrial automatisms, building automatisms or electrical distribution network automatisms.

Hereafter, the term “automatism equipment” will equally refer to an automaton, a numerical control, a monitoring/control station but also any piece of automatism equipment or module having at least one processing unit and capable of executing a program for providing one or several automatism functions. For example, a job module of an automaton, an input/output module of an automaton, a conversational terminal, a variable speed drive, an intelligent sensor or actuator etc . . . will be included in this definition. Such pieces of automatism equipment may be connected to one another through one or more, local or global, automatism networks 15 in order to form an automatism unit 10.

According to a preferred embodiment, FIG. 1 shows an example of communications architecture wherein a Web server 20 is integrated in an automatism unit 10. This Web server 20 is embedded in any piece of automatism equipment belonging to the automatism unit 10. For example, if the piece of automatism equipment is an automaton 11 comprising a central processing unit, the Web server 20 may either be embedded in the central processing unit of the automaton 11 or localized in a module of the automaton 11 communicating with the central processing unit of this automaton 11 through the backplane of the automaton. The Web server 20 may also be a standalone piece of automatism equipment belonging to the automatism unit 10, as indicated in FIG. 1. The Web server 20 communicates with other pieces of automatism equipment 11 of the automatism unit 10 through the automatism network 15.

A communications architecture may also be provided wherein several Web servers capable of being embedded in one or several pieces of automatism equipment are integrated in the automatism unit. For example, a Web server may be embedded in an automaton in its central processing unit and/or one or several Web servers embedded in one or several modules of the automaton.

The Web server 20 is connected to an Internet, Intranet or Extranet type global network 25 and communicates with a network interface 30 also connected to the global network 25. The network interface 30 includes a WAP gateway 31 and is connected through a wireless network 35 to at least a standalone communicating mobile device 40.

According to another embodiment shown in FIG. 2, it might be contemplated that a Web server 20′ is not directly embedded in a piece of automatism equipment of the automatism unit 10. In this case, this Web server 20′ would communicate with the automatism unit 10 through the global network 25 and would either be embedded in any piece of automatism equipment or not. The communications architecture may also include other automatism units 10b, 10c, with which the Web server 20′ would be able to communicate through the global network 25.

The Web server 20 is capable of generating in WML language, either static pages stored in memory or dynamic pages from programs written, for example, in C, JAVA or any other language. These pages and these programs are stored in memory space 21 belonging to the Web server 20. Equivalently, localizing the memory space 21 outside the Web server for example on the global network 25, may also be contemplated. The dynamic pages generated by the Web server may include informative data from the automatism unit 10. These informative data provide various functions for monitoring, viewing and controlling the automatism unit 10. For example, if the automatism unit 10 includes a piece of automatism equipment 11 such as an automaton, these informative data may contain representative variables of the process under the control of the automaton or representative of the different conditions of the automaton.

The network interface 30 performs the forwarding of messages between the global network 25 and the wireless network 35. This interface 30 comprises a WAP gateway 31 which, upon receiving non-compiled WML source contents (WML source or WML script source) from the Web server, transforms them into compiled WML contents (compiled WML or compiled WML script) before transmitting them to a communicating mobile device 40 through the wireless network 35. The compiled WML contents are indeed more compact and so more adapted to wireless network communications. The Web server may also generate compiled WML pages directly, and not require any transformation at the WAP gateway 31. On the other hand, if the bandwidths of the wireless networks become sufficient, the direct sending of WML source contents over a wireless network 35 may then be contemplated.

The communicating mobile device 40 has a navigator 41 which complies with WAP architecture, i.e., is capable of interpreting and displaying pages in WML language so that a user of the mobile device 40 is presented with a man-machine interface.

By means of the WAP navigator 41 implemented in a mobile device 40, a user has the possibility of transmitting a WAP command 33 on the wireless network 35, as schematized in FIG. 3. This command is forwarded by the network interface 30 over the global network 25 so that it is interpreted by the Web server 20. A WAP command 33 consists of a HTTP request which specifies a URL address of the Web server 20, possibly combined with parameters which may also contain complementary requests. For example, these complementary requests include other URL addresses, which are then forwarded by the Web server 20; they may also include one or more requests 13 coded in accordance with a protocol understood by the automatism unit 10, for example requests for reading and writing variables of a piece of automatism equipment 11 of the automatism unit 10. In this case, the Web server sends requests 13 to the automatism unit which analyses them and sends back an answer 14 to the Web server.

On answering a received WAP command, the Web server elaborates a message 24 as static or dynamic pages coded in WML language, by inserting potential informative data from the answer 14 of the automatism unit 10. These pages are routed to the communicating mobile device 40 through the network interface 30 including the WAP gateway 31 which may transform the WML source contents 24 into compiled WML 34. The user is presented with these pages through the WAP navigator 41 of a mobile device 40, thus providing him with the possibility of accessing functions for monitoring, viewing and controlling the automatism unit 10.

The Web server 20 is also able to transmit, on its own initiative or on the initiative of the automatism unit 10, a notification 22 to at least a communicating mobile device 40. For example, the monitoring of a parameter or the occurrence of an event may result in a request for notification 12 initiated by the automatism unit 10; also, the Web server may also poll a variable of the automatism unit 10 and transmit a notification 22 upon the crossing of a threshold. For transmitting a notification 22, a protocol called “Push Access protocol” as defined in the WAP architecture is used. In this notification 22, the Web server 20 includes a list of addresses issued from a directory of addresses which is either stored locally in memory 21 or remotely on the global network 25. Upon receiving a notification 22, the network interface 30 transforms the list of addresses into a list of dialling numbers for mobile devices 40. Then, according to a pre-established method, the network interface 30 routes the notification 32 towards one or several addressees 40. This functionality thus enables the user of a WAP navigator 41 implemented in a mobile device 40, to be informed at any moment on events or conditions concerning the automatism unit 10. For instance the notification comprises a message viewed on the WAP navigator 41 by means of a WML page, associated with a URL address which the user may address, provided that a WAP command 33 is sent by the latter as described earlier.

Accesses to the Web server 20 are systematically protected by means of a firewall interface 26 for making communications, more particularly access to information of the automatism unit 10, and notification transmitters, secure. Different password or encryption techniques may be used for this firewall interface 26. It is thereby understood that the HTTP messages are written in accordance with the HTTP/S protocol which integrates security functionality.

It is clearly understood that other alternatives and detailed enhancements may be devised without departing from the scope of the invention and the use of equivalent means may also be contemplated.

1. A system for accessing a programmable automatism unit (10) based on a WAP architecture, for at least a standalone communicating mobile device (40), such as a portable telephone, which integrates a navigator (41) complying with WAP architecture, wherein the automatism unit (10) includes one or several pieces of automatism equipment, characterized by the fact that this system includes:
a Web server (20), embedded in a piece of automatism equipment of the automatism unit (10), capable of generating static or dynamic informative data coded according to the WML language, whereby such informative data may provide functions for monitoring, viewing and controlling the automatism unit,
a network interface (30), connected to the Web server (20) by a global network (25) of the Internet, Intranet or Extranet type which authorizes access to said informative data from the WAP navigator (41) of a communicating mobile device (40) through a wireless network (35), in such a way that a user of such a WAP navigator (41) may access functions for monitoring, viewing and controlling the automatism unit (10).

2. The access system according to claim 1, characterized by the fact that the network interface (30) comprises a WAP gateway (31) which, upon receiving from the Web server (20) informative data according to WML source contents, transforms them into compiled WML contents before transmitting them to a communicating mobile device (40).

3. The access system according to claim 1, wherein the automatism unit (10) comprises at least an industrial automaton (11) having a central processing unit, characterized by the fact that the Web server (20) is either embedded in the central processing unit of the automaton (11) or embedded in an automaton module connected to the central processing unit of the automaton (11).

4. The access system according to claim 1, wherein the automatism unit (10) comprises several industrial automata (11) having a central processing unit and access to a local or global automatism network (15), characterized by the fact that the Web server (20) is connected to the automatism network (15) in order to be able to communicate with the central processing units of these automata (11).

5. The access system according to claim 2, characterized by the fact that the Web server (20) may receive through the network interface (30), a WAP command (33) as a HTTP request specifying a URL address optionally associated with parameters which may notably contain complementary requests and, on answering this WAP command, the Web server (20) generates static or dynamic informative data in WML languages which may provide the user of a WAP navigator (41) implemented in a communicating mobile device (40), with functions for monitoring, viewing and controlling the automatism unit (10).

6. The access system according to claim 2, characterized by the fact that the Web server (20) may send, on its own initiative or on the initiative of the automatism unit (10), a notification (22) to at least a communicating mobile device (40) by using the “Push Access Protocol” as defined in WAP architecture, so that the user of a WAP navigator (41) implemented in a communicating mobile device may be informed on events or conditions concerning the automatism unit.

7. The access system according to claim 6, characterized by the fact that the Web server (20) includes in the notification (22) a list of addressees which stems from an addressee directory stored in a local memory or in a remote memory on the global network (25).

8. A programmable automatism unit characterized by the fact that it enables at least a mobile device (40) communicating through a wireless network (35) and integrating a WAP navigator (41), to access functions for monitoring, viewing and controlling the automatism unit (10) according to any of the preceding claims.
